(19) United States
(12) Patent Application Publication
(10) Pub. No.: US 2013/0094648 A1
(43) Pub. Date: Apr. 18, 2013

(54) Apparatus and Method for Producing a Bit Sequence

(71) Applicant: Infineon Technologies AG, Neubiberg (DE)

(72) Inventors: Rainer Goettfert, Putzbrunn (DE); Berndt Gammel, Markt-Schwaben (DE); Jan Otterstedt, Unterhaching (DE)

(73) Assignee: Infineon Technologies AG, Neubiberg (DE)

(21) Appl. No.: 13/648,634

(22) Filed: Oct. 10, 2012

(30) Foreign Application Priority Data
Oct. 12, 2011 (DE) 102011054410.0

(51) Int. Cl. H04L 9/28

(52) U.S. Cl. CPC H04L 9/28
USPC 380/28

(57) ABSTRACT

A method for reconstructing a physically unclonable function (PUF) A for use in an electronic appliance is provided. The method includes producing a checksum C, producing a defective PUF B and reconstructing the PUF A from the defective PUF B using an error correction algorithm. The algorithm produces a plurality of ambiguous results (A₁, A₂, . . . , Aₙ) for the PUF A in a fraction of the cases and a single result, which may be incorrect, in all other cases. The method also includes determining by means of the checksum C which of the plurality of ambiguous results (A₁, A₂, . . . , Aₙ) is the correct PUF A or of whether a single result corresponds to the correct PUF A.

### PRIORITY CLAIM

This application claims priority to German Patent Application No. 10 2011 054 410.0, filed on 12 Oct. 2011, the content of said German application incorporated herein by reference in its entirety.

### TECHNICAL FIELD

The invention is in the field of cryptography, and more particularly relate to an apparatus and a method for reconstructing a physically unclonable function (PUF), particularly for use in an electronic chip card.

### BACKGROUND

The abbreviation PUF stands for ‘physically unclonable function’, also called a physical hash function. The underlying concept is to digitize physical properties of an object and in this way to obtain a bit sequence that is associated with the object. In this context, it is desirable for the bit sequences of two different physical objects to be uncorrelated. A simple example for illustration is a sheet of paper. When viewed under a microscope, it is possible to see a special fine structure of woodchips or cellulose portions. The structure is measured and is presented as a bit sequence by using a suitable algorithm. This bit sequence is the PUF associated with the sheet of paper. Another sheet of paper will generally provide a totally different bit sequence, that is to say a bit sequence which is uncorrelated to the bit sequence of the first sheet. The terms “bit sequence” and “bit string” are used synonymously below.

The process of producing a bit sequence (the PUF) from the properties of a physical object is called PUF generation. A main use of PUFs is the production of cryptographic keys for fully electronic or computerized encryption methods. By way of example, it would be possible to use the PUF bit string itself as a cryptographic key. Alternatively, it would be possible—and has particular advantages—to compress the PUF bit string to form a short bit string and to use the latter as a cryptographic key. The latter method is usually used for chip cards, where a mechanism for PUF generation is integrated in the electronics of the card. In this way, the PUF generation and the use thereof for key production prevents the key itself from having to be stored on the card, which would present a security risk.

A desirable property of a PUF mechanism is that the same physical object, that is to say the same chip card, for example, results in the same bit sequence each time in the course of fresh PUF generation. This will, in particular, also be true under different ambient conditions, such as temperature, air humidity, brightness, electrical and magnetic field strengths, etc.

This is not the case in general, however. Repeated PUF generations for the same physical object generally delivers different bit sequences. Although the bit sequences are quite similar among one another, they are not absolutely identical to one another. Attempts are made to compensate for this deficit by means of methods of coding theory (error correction).

The procedure in this case is as follows. There is a physical object. At the beginning, the PUF bit sequence A associated with the object is produced. The bit string A is thus the result of the first PUF generation operation. The bit sequence A is considered in the same way as a message in coding theory which needs to be transmitted via a channel that is susceptible to noise, the transmission being expected to involve the occurrence of errors, i.e. the collapse of individual bit entries, that is to say that a zero becomes a one or vice versa. In coding theory, this problem is countered by providing the message A with a redundancy R and transmitting the code word (A, R). If errors occur during the transmission, they can be corrected using coding theory methods owing to the redundancy R. Following correction, the error-free message word A is obtained again.

The same concept is used in PUF generation. The original PUF value A (the value arising in the first PUF generation operation) is referred to as the true PUF value. From the true PUF value A, an associated redundancy value R is calculated. R is called auxiliary information, and R is intended to be used—at a later time—to successfully reconstruct the true PUF value A.

For the sake of simplicity, it has been assumed in this case that the true PUF value A is that bit string which arises in the very first PUF generation operation. In fact, the true PUF value of a chip card is determined during production in the course of chip personalization, for example. In this case, it is customary to produce a PUF value multiple times or frequently in succession, and to define the mean value or the most frequent value as the true PUF value, for example. Another approach is to schedule a reserve. It is assumed that an 800-bit PUF value is required. However, a 1000-bit PUF value is produced (by way of example) in order to have the reserve. In the factory, the 1000-bit PUF value is then produced multiple times, for example 100 times. Each bit position that is not stable during these 100 production operations, that is to say it does not always show the same bit value, is declared invalid. It is assumed that there are 840 positions at which the same bit value occurred each time during the 100 PUF generation operations. Of these 840 positions, 800 are then selected, for example, and these 800 positions define the true PUF value.

The value R calculated using the coding algorithm is stored. For security reasons, the PUF value A itself is not stored and is therefore also not always available. The reason is that the PUF value A is used directly as a cryptographic key, or a cryptographic key is derived from it. If the PUF value A were easily accessible, it would be no longer possible to consider the associated cryptographic key as secret. During later fresh PUF generation, a new PUF value B is obtained. The value B is generally not identical to A, but differs from A only slightly. The aim is to recover the true PUF value A from the available value B.

This is accomplished by using R and coding theory methods:
B→(B,R) (A,R)→A

The current and present PUF value B is thus extended by the auxiliary information R, with A, B and R being bit strings. The bit sequence (B, R) is then considered to be an erroneous word within the context of coding theory and the error is then corrected using coding theory. The corrected word (A, R) is obtained. In particular, the true PUF value A is available.

The task of reconstructing the true PUF value A from the most recently produced and currently present PUF value B succeeds only if B does not differ too greatly from A. In the terminology of coding theory: if not too many errors have occurred during the generation of B, considered relative to the original true PUF value A.

The technical implementation of a PUF governs how greatly a newly generated PUF value B typically differs from the true PUF value A, that is to say how many errors typically need to be corrected. Depending on the technical implementation of the PUF, B will differ from A in fewer than 1% of the positions, for example in 0.3% or 0.6%, or in up to 15%. The more B differs from A on average, the greater and more costly the hardware implementation of the PUF reconstruction algorithm. This also means higher production costs, greater space requirement and possibly higher power consumption.

There are several reasons for this. If the intention is to form a 128-bit secret key from the PUF value, for example, the following parameters are obtained. The higher the error rate (that is to say the more B differs from A), the longer the bit strings A and B must be in order to result in a secure 128-bit key at the end. If, by way of example, 15% errors occur in B in comparison with A, then A (and hence also B) must be approximately 4000 bits long in order to yield a 128-bit secret key. If only 1% errors occur, A and B would need to be approximately 600 bits long in order likewise to provide a 128-bit secret key. The values and ratios indicated above are calculated by using coding theory, and this calculation is known to a person skilled in the art and therefore does not need to be explained in more detail at this juncture.

The more errors that occur, the more powerful the error correction algorithm used needs to be, and the more complex and hence expensive is the implementation thereof.

A PUF mechanism having a fixed error rate which cannot be changed will be assumed. An error-correcting code which is currently capable of correcting the errors that occur, that is to say reconstructing the true PUF value A from B, for example, is then chosen.

In this context, a code is referred to as “well-designed” if the error correction therewith succeeds on average up to once in 1 million cases (1 ppm=1 part per million). A code in which the error correction fails for example only once in one billion cases (or more rarely) will be referred to as “over-designed” in this context. A code in which the correction is unsuccessful in just one of 10,000 cases (or fewer) will be deemed “under-designed”. The expression “well-designed” relates to the circumstance that a reliability of 1 ppm in PUF reconstruction is deemed sufficient in most practical cryptographic applications. The cited reference value of 1 ppm for a “well-designed” code is intended to be understood only as a typical example in this case. It may also, depending on the application, be significantly lower (automotive engineering, aviation) or higher (low-priced products from the consumer goods sector).

An “over-designed” code has the advantage of a high level of reliability, but at the cost of a correspondingly expensive error correction algorithm. By way of example, the hardware module which is an implementation of the error correction algorithm would have a large surface area and a high power consumption.

An “under-designed” code would be attractive on account of the relatively low implementation costs for the hardware. The reliability of 10,000 to 1 is unacceptable for most applications, however.

Against this backdrop, conventional chip cards implement a “well-designed” error correction algorithm for a given PUF with a particular error rate. The drawback of this variant is that the chosen algorithm requires relatively expensive hardware implementation. There are primarily two reasons why the demands on the hardware grow: the higher the reliability of the PUF reconstruction is intended to be, the more powerful, that is to say more computation intensive, the error-correcting code needs to be; and the higher the PUF value A (or B) needs to be. Both factors contribute to the PUF module having more switching elements, that is to say a larger hardware surface area, and a higher power consumption, and at the same time the decoding taking a larger amount of execution time. The complexity generally increases significantly more sharply than linearly with the length of the code. This is a severe impediment to the broad use of chip-specific PUF keys in numerous product areas.

As such, there is a need for methods and apparatuses which allow PUF generation while avoiding the drawbacks mentioned above.

### SUMMARY

According to an exemplary embodiment, a method for reconstructing a PUF A for use in an electronic appliance is provided. The method comprises providing a checksum C, producing a defective PUF B and reconstructing the PUF A from the defective PUF B using an error correction algorithm. The algorithm produces a plurality of ambiguous results (A₁, A₂, . . . , Aₙ) for the PUF A in a fraction of the cases and a single result, which may be incorrect, in all other cases. The checksum C is used to determine which of the plurality of ambiguous results (A₁, A₂, . . . , Aₙ) is the correct PUF A, or whether a single result that has been obtained corresponds to the correct PUF A.

According to a further exemplary embodiment, an apparatus for reconstructing a PUF A is provided. The apparatus comprises a unit operable to produce a defective PUF B, a read only memory operable to store a checksum C and a computation unit operable to reconstruct the PUF A from the defective PUF B by means of an error correction algorithm. The algorithm produces a plurality of ambiguous results (A₁, A₂, . . . , Aₙ) for the PUF A in a fraction of the cases and a single result, which may be incorrect, in all other cases. The algorithm also determines by means of the checksum C which of the plurality of ambiguous results (A₁, A₂, . . . , Aₙ) is the correct PUF A or whether a single result that has been obtained corresponds to the correct PUF A.

The invention also relates to an apparatus for executing the disclosed methods and also comprises apparatus portions for executing respective individual method steps. These method steps can be executed by hardware components, by a computer programmed by means of appropriate software, by a combination of the two or in any other way. Furthermore, the invention is also directed at methods according to which the respectively described apparatuses operate. It contains method steps for executing every function of the apparatuses.

Those skilled in the art will recognize additional features and advantages upon reading the following detailed description, and upon viewing the accompanying drawings.

### BRIEF DESCRIPTION OF THE DRAWINGS

The invention will be explained below using exemplary embodiments which are shown in figures and from which further advantages and modifications arise.

FIG. 1 shows a method for producing a checksum according to embodiments of the invention.

FIG. 2 shows a schematic illustration of an apparatus for producing a checksum according to embodiments of the invention.

FIG. 3 shows a schematic illustration of error correction according to embodiments.

FIG. 4 schematically shows a method for reconstructing a PUF according to embodiments.

FIG. 5 shows a schematic illustration of a chip card according to embodiments.

### DETAILED DESCRIPTION

The text below describes various embodiments of the invention, some of which are also shown by way of example in the figures. In the description of the figures which follows, identical reference symbols relate to components which are the same or similar. In general, only differences between different embodiments are described. In this context, features which are described as part of one embodiment can also readily be combined in connection with other embodiments in order to produce yet further embodiments.

Exemplary embodiments of the invention relate to the use of an “under-designed” code in the reconstruction of a PUF, that is to say that the reliability in the reconstruction is typically equal to or worse than 1 to 10,000. Depending on the application, however, codes with a significantly better reliability can also be deemed under-designed. The yardstick is whether or not the reliability is regarded as satisfactory for the application in question. As compensation of the error rate that occurs, or the statistically occurring indefiniteness or ambiguity of the results, a further auxiliary variable C, what is known as the PUF checksum, is introduced to complement the auxiliary variable R (the redundancy). In this case, the auxiliary variables R and C can be chosen such that the PUF reconstruction succeeds with a reliability of more than 1 to 1 billion despite the high error rate of the under-designed code. The introduction of C thus increases the reliability of the PUF reconstruction such that it corresponds to an over-designed code, for example, without having the drawbacks of an over-designed code.

A PUF value A that has been produced, in the form of a bit string, is thus assigned a checksum C, a typically much shorter bit string. The checksum C is used for reconstructing the true PUF value A from a newly generated PUF value B. In this case, the checksum C is used in two respects, firstly to verify the correctness of the PUF reconstruction and secondly as a decision criterion for ambiguities in the error correction.

On account of the use of the under-developed (under-designed) code, the error correction is not always explicit. By way of example, it could be ambiguous in approximately 1 in 10,000 cases. That is to say that there are then a plurality of solutions for A pertaining to a present PUF value B and the stored redundancy R. Using the checksum C, however, it is possible to determine the true PUF value A from the set of different solution candidates in almost all cases.

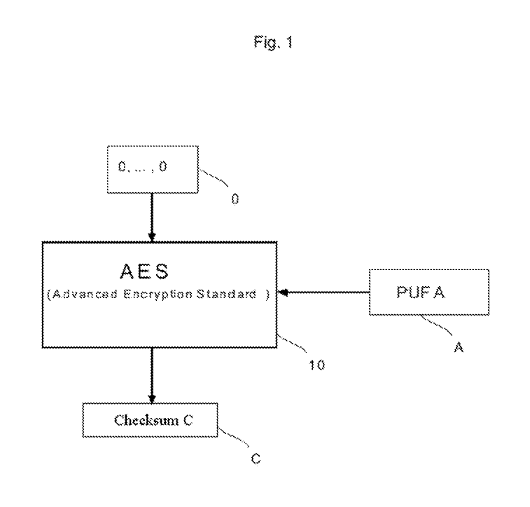

FIG. 1 shows the production of a PUF checksum C according to exemplary embodiments. A cryptographic block cipher, for example the Advanced Encryption Standard (AES), is used for producing the checksum. By way of example, this is suitable when an AES module 10 is provided on the chip on which the PUF mechanism is implemented, as is the case on many chip cards. The plain text used is an arbitrary constant 128-bit string. By way of example, a string 0 which contains 128 zeroes. The key used for the AES encryption is the true PUF value A. The AES key has 128 bits. Other possible key lengths such as approximately 192 and 256 bits can be used, but this is irrelevant in this case. The PUF value A will typically be longer than 128 bits. By way of example, the PUF value A will be assumed to have a length of 1000 bits. In that case, the PUF value A is extended by 24 bits, which are all zeroes, for example. The extended PUF string now has 1024 bits. 1024 corresponds to 8 times 128. The extended PUF value is divided into 8 blocks of length 128. Let A1, A2, . . . , A8 be these eight blocks. The eight blocks are then used in order as AES keys. They are each used to encrypt the plain text 0=00 . . . 0. In this case, eight ciphers C1, C2, . . . , C8 are obtained. These are eXORed on a bit-by-bit basis. The XOR sum:

C=C1 XOR C2 XOR . . . XOR C8

is the desired PUF checksum C.

A further possibility for producing the PUF checksum C with AES according to exemplary embodiments involves eXORing the above eight segments A1, A2, . . . , A8 on a bit-by-bit basis to form the 128-bit vector V. In that case, V is used as the AES key. The cipher C obtained is the PUF checksum.

AES is generally considered to be strong encryption. Therefore, it will be practically impossible in the two methods just described to draw conclusions as to the true PUF value A from the checksum C. It is therefore possible for the PUF checksum C to be stored in a read only memory such as the EEPROM or another memory of the controller, for example, which means that it can be regarded as more or less public. The PUF checksum C can even be stored in a publically accessible database without thereby compromising the security of the true PUF value A.

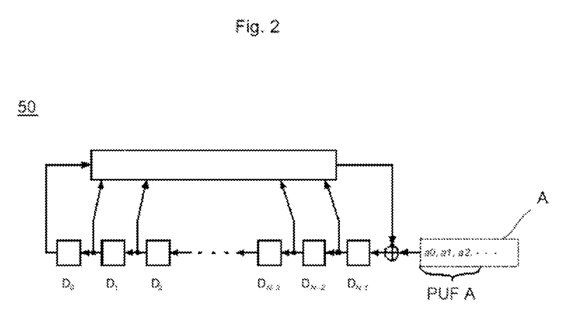

A further example of the production of the checksum C for a given PUF value A according to exemplary embodiments is shown in FIG. 2. In this case, a linear feedback shift register 50 is used. The linearity of the feedback shift register is not fundamental in this case; it may also be nonlinear in embodiments. The shift register embodiment may be of particular interest when there is no strong cryptographic module implemented on the appliance/chip card or the controller thereof.

A PUF value A of arbitrary length can be fed into the feedback shift register 50. The length N of the shift register 50, that is to say the number of flipflops D₀ to D_{N-1}, is simultaneously the length of the resulting PUF checksum C. The initial content of the shift register 50 may be arbitrary. The all-zeros state, in which each cell contains zero, is also permissible. When the PUF value A has been read into the shift register 50 completely, the final content of the shift register 50 is the PUF checksum C. The cells of the shift register 50 are thus read in order to obtain the checksum C.

The length N of the shift register 50 and the length of the PUF value A may be arbitrary, with the restriction that the shift register 50 is no longer than the PUF value A. In some exemplary embodiments, the shift register 50 may be substantially shorter.

The shift register 50 should not be too small, however, because otherwise the validity of the checksum becomes too low. Finally, the purpose of the checksum is to be useful for PUF reconstruction. By way of example, it will be assumed that the shift register 50 has the length 64, which is a feasible value (without being limiting).

The probability that the PUF reconstruction is erroneous, that is to say that the coding algorithm has been used to obtain from the newly generated PUF value B a corrected PUF value A′ which does not match the true PUF value A completely, however, and that at the same time the checksum does not help to detect this error, is 1 in 2⁶⁴. In general, the probability for a shift register of length N is equal to 1 in 2^{N}. For this reason, the shift register 50 should be chosen to be sufficiently large.

It is assumed that the shift register 50 has the length N. The shift register 50 may be linear or nonlinear. The length of the PUF value A is greater than or equal to N. The initial content of the shift register 50 is chosen permanently, but may be arbitrary. The following is then true, referred to here as Axiom 1: if the supplied PUF value A is genuinely random and hence evenly distributed, each of the possible 2^{N} different final contents of the shift register 50 has the same probability of occurring. In other words, the resulting N-bit checksums are likewise evenly distributed.

The following statements will be combined under the designation Axiom 2 in this case: the aforementioned property from Axiom 1 is an important reason to use feedback shift registers to produce PUF checksums. However, unlike in the example in FIG. 1, the checksum C generated by means of shift registers is not produced by a cryptographically strong method, even when the shift register 50 is nonlinear. Knowledge of the checksum C thus allows a hacker to draw conclusions as to the true PUF value A. The same also applies to the redundancy R which has been calculated from the true PUF value A using the coding algorithm and which is required in order to reconstruct the true PUF value A together with the checksum C.

The redundancy R and the checksum C can again be regarded as public information. In order to ensure the security or secrecy of the cryptographic key which is extracted which is extracted from the true PUF value A, the following condition therefore needs to be borne in mind: the bit length of the secret is provided by the bit length of the true PUF value A minus the bit lengths of the redundancy R and minus the bit length of the shift-register-generated checksum C. In exemplary embodiments, C may have a length from 30 bits to 150 bits, and the true PUF A and the current PUF B may have a length from 100 bits to 5000 bits. The average error rate for producing the PUF B ranges from approximately 0.3% to 15%, more typically from 0.5% to 10%.

In one nonlimiting exemplary embodiment, the true PUF value A is assumed to have a length of 800 bits. The redundancy R which is required by or for the execution of the error correction algorithm is assumed to have 600 bits. The aim is to obtain from the PUF value a secure, 128-bit cryptographic key. In this example, the shift register 50 used for producing the PUF checksum C may have a length of no more than 72 cells, because according to the above specification 800−600−72=128.

FIG. 1 presents a cryptographic block cipher, and FIG. 2 presents a linear shift register 50 for producing a checksum C for an under-designed code. In principle, however, any function which has the even distribution property from Axiom 1 above is suitable for calculating the checksum. Such functions are known as hash functions. For these, the statement from Axiom 2 that the checksum value can be considered to be public and hence the bit length of the secret is reduced is true.

If a hash function has what is known as the one-way property (OWF, one-way function), however, then it can be stored publically without disclosing the information about the cryptographic key. The use of these “cryptographic hash functions” (for example the known SHA-1, SHA-2, Whirlpool algorithms) is appropriate, by way of example, when there is an appropriate module on the controller. Thus, FIG. 1, for example, shows how AES is used to produce a cryptographic hashsum C.

As already described above, the PUF checksum C has two functions: a) it allows a check as to whether errors have been corrected in the right way; and b) it provides a decision criterion for the ambiguous error correction. Property b) is explained below. For this purpose, there first of all follow a few facts from coding theory. Consider a binary linear (n, k, d) code. The parameters n, k, d have the following meaning. Parameter n is the code word length, that is to say the number of bits in a code word. Parameter k is the dimension of the code. This means that there are precisely 2̂k=2^{k} (2 to the power of k) different code words (k is always smaller than n). There are 2̂n different n-bit words, but only 2̂k of these n-bit words are code words. The set of all the 2̂n n-bit words forms—mathematically, in the sense of linear algebra—an n-dimensional vector space V. The set of all the code words is a k-dimensional subspace of V. Parameter d stands for the minimum distance of the linear code. The minimum distance d is the shortest possible interval at which two different code words can be from one another.

The interval between two code words, or generally the interval between two n-bit words (also called Hamming distance), is equal to the number of the different bit positions. By way of example, the two 8-bit words a=(11001010) and b=(10101010) are at the Hamming distance d (a, b)=2 from one another.

The minimum distance d is the crucial parameter for the error correction capability of a code. The greater the minimum distance, the more errors the code is able to correct.

The error correction is based on the following principle: at the beginning, there is a code word. This means that the transmitted message, or the stored message, is always available in the form of one or more code words.

When transferred to the PUF generation according to exemplary embodiments, the situation is somewhat more complicated. However, it is true in all cases that the true PUF value A is linked to a (or a plurality of) code word(s), as a result of which coding theory methods are used when reconstructing the true PUF value A from the newly generated PUF value B.

When the message is sent via a channel which is susceptible to interference, or during the storage of the message on a storage medium, or during fresh PUF generation, errors can occur. If no errors occur, the message is identical to the original code word.

If errors have occurred, however, then the present (erroneous) message is generally no longer a code word. However, the following is true: if fewer than d/2 errors have occurred (per code word), there is precisely one code word which is closest to the available message. The task of the error correction (i.e. of the decoding algorithm) is to determine this explicitly determined code word, in other words to reconstruct the original message from the present erroneous message. This is referred to as “nearest neighborhood decoding”.

However, if more than d/2 errors have occurred, as an example r errors where r>=d/2 (r is greater than or equal to d/2), then generally the present (erroneous) message can no longer be explicitly associated with a code word. In general, the following is then true: the sphere of radius r around the present message word contains a plurality of code words.

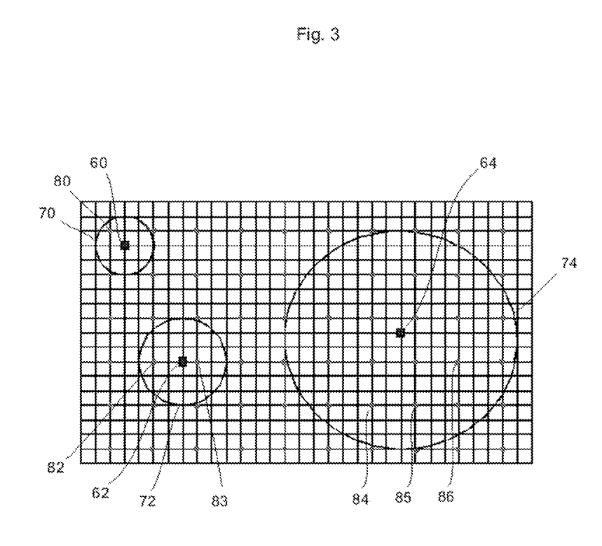

The situation is illustrated geometrically in FIG. 3. Three received messages 60, 62, 64 are illustrated by small squares in the center of three corresponding circles 70, 72, 74. Each point of intersection between a horizontal and a vertical line (i.e. each grid point in FIG. 3) is a possible message. The smaller points, arranged regularly in a 3×3 matrix, represent code words.

FIG. 3 shows three spheres 70, 72, 74 of different magnitude around the respective message word. The small sphere 70 has a radius r<d/2, and this sphere contains precisely one code word 80. Correction of the message involves it being replaced by the explicitly determined code word within the sphere. This is the effect of a decoding algorithm.

The medium sphere 72 contains two code words 82, 83. The radius of this sphere is somewhat larger than d/2. The message (represented by the small central square 62) therefore cannot be corrected explicitly. An additional criterion is required that states which code word is meant to replace the message.

The radius of the largest sphere 74 is much greater than d/2. This sphere 74 contains 18 different code words (84, 85, 86, . . . , not all being referenced for reasons of clarity). It is no longer possible, or is possible only with enormous complexity, to determine the correct code word.

The term “sphere of radius r around the message word a” is explained in more detail next. In an example, let a=(10111110) be an 8-bit message. The sphere of radius r=3 around a comprises all 8-bit words which are at the Hamming distance 0, 1, 2 or 3 from a.

These are 1+8+28+56=93 words in total. The reason is that there is one word, namely a itself, which is at Hamming distance 0 from a. There are precisely 8 words at Hamming distance 1 from a. There are 28 (=8 over 2) words at Hamming distance 2 from a. And there are precisely 56 (=8 over 3) words at Hamming distance 3 from a.

The first case from FIG. 3, the small sphere 70, can be accomplished using the decoding algorithm alone. The auxiliary information R is sufficient for this.

In the second case in FIG. 3, the sphere 72 of medium magnitude, the coding theory provides two possible solutions: the two possible code words within the sphere 72. This required the auxiliary information R. In order to find out which of the two solutions is the correct one, the checksum is calculated for both solutions, and the check sums obtained are compared with the additional auxiliary information C. The solution for which the checksum is identical to C is accepted as the correct solution.

In the third case, the largest sphere 74 in FIG. 3, the complexity is too great. In this instance, the reconstruction of the PUF value fails.

In a further, nonlimiting exemplary embodiment, an illustration will be provided by a case in which the PUF value A is 480 bits long. The aim is again to obtain a secret 128-bit key from the PUF value A. For the error correction, a linear code of length n=15 and of minimum distance d=7 is used by way of example.

The PUF value A is broken down into 32 segments of length 15: A=(A_{—1, A}_2, . . . , A_32). Each 15-bit segment is handled individually. Thus, let A_j be one such 15-bit segment. On account of the minimum distance d=7, all 1-bit, 2-bit and 3-bit errors in A_j can be corrected explicitly. Ten redundancy bits are required for the error correction. Let R_j be the row vector which contains these ten redundancy bits for A_j. Since there are 32 segments A_1, A_2, . . . , A_32, there are also 32 redundancy vectors R_1, R_2, . . . , R_32. These 32 redundancy vectors form the auxiliary information H_1. The auxiliary information H_1 thus comprises 320 bits.

Auxiliary information H_2 is implemented by a 32-bit LFSR: the 480-bit PUF value A is fed into the 32-bit linear feedback shift register (LFSR). The initial content of the LFSR may be arbitrary. The shift register could initially be filled completely with zeroes, for example. When the 480-bit PUF value has been fed in, the LFSR is at any rate in a particular state. The 32-bit row vector, which describes the state of the LFSR, forms the checksum C. The checksum C is the auxiliary information H_2.

The two pieces of auxiliary information H_1 (320 bits) and H_2 (32 bits) are stored in an EEPROM (or another memory element of a controller) in this example. Hence, there are 352 bits of information about the PUF string A in the (nonsecure) EEPROM. There remain 480−352=128 secret bits. Hence, a 128-bit cryptographic key can be extracted from the 480-bit PUF string A.

Let B be the PUF value newly generated at a later time. The aim is to reconstruct A from B. The 480-bit bit string B is broken down into 32 segments B_1, B_2, . . . , B_32, which are each 15 bits long. The 32 segments B_j are handled individually, that is to say that A_j is intended to be reconstructed from B_j. If this is successful for each of the 32 segments, the aim of reconstructing the true PUF value A from the available PUF value B would therefore have been achieved. The checksum C was then not needed at all. However, it can be used as a “double check” in order to check whether the reconstructed A, having been fed into the LFSR, results in a final content of the LFSR which is identical to the checksum C=H_2.

In order to obtain the segment A_j from B_j, the procedure is as follows:

1. Fetch the redundancy vector R_j from the EEPROM.

2. Append R_j to B_j: this results in the 25-bit row vector (B_j, R_j).

3. The 25-bit row vector (B_j, R_j) is then allocated a 10-bit vector, what is known as the syndrome. The syndrome then forms the input for a suitable decoding algorithm. If a decoding algorithm is not available, or if it undesirable to implement such a decoding algorithm as a separate hardware module for reasons of cost, then there is always also the option of accomplishing the decoding (that is to say the error correction) using a syndrome table. The syndrome table can be implemented in software or in hardware. The decoding is then performed by means of a table look-up.

In this case, the syndrome has 10 bits. A syndrome can therefore be represented as a 10-bit number, that is to say as an integer between 0 and 1023. The syndrome table thus comprises 1024 rows. The left-hand column contains the syndrome, an integer from 0 to 1023. Beside that are the associated error positions. If no error has occurred (that is to say if B_j=A_j) then the syndrome is equal to zero. The syndrome being equal to 0 is therefore interpreted as a sign of freedom from error.

If it is merely explicit error correction that is desired, the syndrome table would have the following appearance: there are 15 different syndromes to which a 1-bit error corresponds. That is, precisely 15 rows of the syndrome table would contain, to the right of the syndrome, precisely one number between 1 and 15, which indicates the position of the 1-bit error in the 15-bit vector B_j. In one example, such a row could have the following appearance: syndrome=177, error position 8.

There are 105 (=binomial coefficient 15 over 2) different syndromes to which a 2-bit error corresponds. That is, precisely 105 rows of the syndrome table would contain, to the right of the syndrome, a pair comprising two numbers between 1 and 15, both of which indicate error positions. In one example, such a row could have the following appearance: syndrome=65, error positions (3, 11).

There are 455 (=binomial coefficient 15 over 3) different syndromes to which a 3-bit error corresponds. That is, precisely 455 rows of the syndrome table contain, to the right of the syndrome, a triple comprising three numbers. In one example, such a row could have the following appearance: syndrome=522, error positions (4, 7, 15).

There are 488 syndromes to which a multi-bit error (in the sense of 4 or more errors) corresponds. The number x=488 is obtained from 1024=1+15+105+455+x. That is, 488 rows remain empty in the syndrome table. Beside the syndrome in such a row, it would be possible to write: “multibit error”.

For reasons of economy, these 488 rows of the syndrome table could be omitted entirely.

The syndrome table would then be used as follows:

1. Receive B_j

2. Form (B_j, R_j)

3. Calculate the associated syndrome S

4. If S=0, conclude that no error has occurred. Otherwise, if S is not equal to 0, find S in the syndrome table. If S occurs in the table, take the error positions from the table and correct B_j accordingly. If S does not occur in the table, the task is abandoned (this means that four or even more errors have occurred in B_j).

For ambiguous error correction, the syndrome table needs to be expanded. The extent of the expansion is dependent on how many errors are intended to be corrected. It is assumed that all 4-bit errors are still intended to be corrected. In that case, the syndrome table now contains rows which showed “multibit error” in the previous example and which now have the following form, for example:

syndrome=199, error positions (1, 3, 5, 9); (2, 7, 11, 13) (*)

This means that when the syndrome is 199, this may be the case because a 4-bit error has occurred at positions 1, 3, 5 and 9. Alternatively, it may be that there is a 4-bit error at 2, 7, 11 and 13. The error correction is thus ambiguous. The syndrome does not allow a decision to be made as to which is the correct case. For this, the checksum C is required.

Back to the example. Consider the 32 segments B_1, B_2, . . . , B_32. By way of example, the syndrome 199 is obtained in segment B_1, corresponding to the situation in the row above (*).

It is assumed that for segment B_2 the syndrome 789 is obtained, and the syndrome table contains the row:

syndrome=789, error positions (2, 4, 7); (1, 5, 11, 15)

It is assumed that, for the remaining 30 segments B_3, B_4, . . . , B_32, a respective syndrome was obtained which was either zero or resulted in a row in the syndrome table which contained no 4-bit error or multibit error. These 30 segments were able to be corrected explicitly. The uncertainty (ambiguity) exists only for segments B_1 and B_2.

There are now two available options for correcting B_1, and there are likewise two options for correcting B_2. Hence, there are a total of four options for deriving segments (A_1, A_2) from (B_1, B_2). Each of these four options is extended to form a PUF value A using the available explicitly determined solutions A_3, A_4, . . . , A_32. Thus, there are four candidates for a PUF value A.

In order to determine which of the four candidates is the correct one, each of these 4 values is fed into the LFSR, and the resulting final content is compared with the checksum C. It is to be expected that only one of the 4 final contents obtained matches C. This is then the correct, reconstructed PUF value A.

The values for R and also for C are considered to be error-free in all cases, since they (unlike the PUF itself) have been stored deliberately and possibly with the protection of a separate code. Therefore, all syndromes which indicate errors in one of the R_j are excluded. This helps to reduce the number of ambiguities.

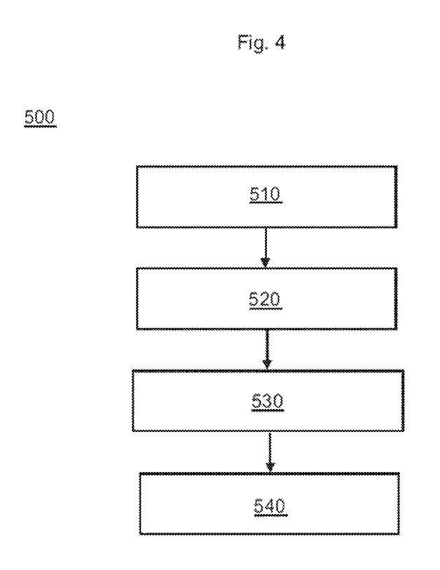

FIG. 4 shows a schematic overview of a method 500 for reconstructing a PUF A according to exemplary embodiments. In step 510, a checksum C is provided in a read only memory. In step 520, a defective PUF B is produced. In step 530, a PUF A is then reconstructed from B using an error correction algorithm, the algorithm being designed such that it produces a plurality of ambiguous results (A₁, A₂, . . . , Aₙ) for the PUF A in a fraction of the cases and a single result, which may be incorrect, in all other cases. In step 540, the checksum C is then used to determine either which of the plurality of ambiguous results (A₁, A₂, . . . , Aₙ) is the correct PUF A or whether a single result that has been obtained corresponds to the correct PUF A.

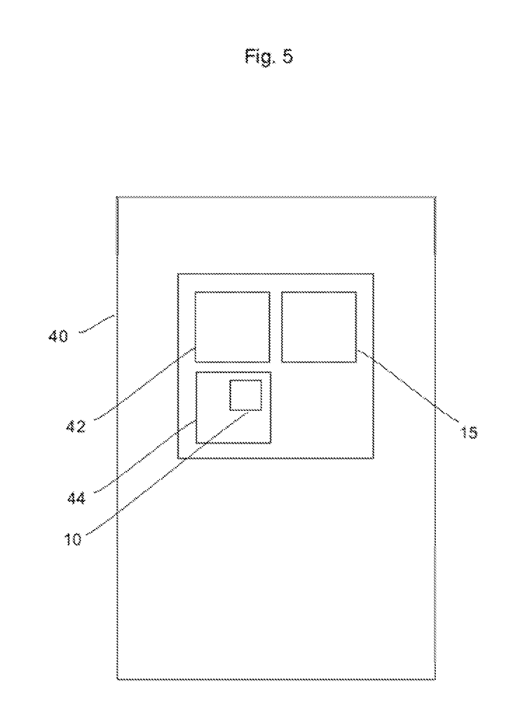

FIG. 5 schematically shows a chip card 40 with an apparatus for reconstructing a PUF A according to embodiments. The chip card 40 comprises a unit 42 for producing a defective PUF B, and also a read only memory 15 which stores a checksum C. In addition, the chip card 40 comprises a computation unit 44, designed to reconstruct a PUF A from B using an error correction algorithm. Preferably, the computation unit 44 comprises a cryptographic module 10 with an implementation of the AES method, but it is also possible for any other encryption methods that are known to a person skilled in the art to be implemented.

Terms such as “first”, “second”, and the like, are used to describe various elements, regions, sections, etc. and are not intended to be limiting. Like terms refer to like elements throughout the description.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A method for reconstructing a physically unclonable function (PUF) A for use in an electronic appliance, the method comprising:
producing a checksum C;
producing a defective PUF B;
reconstructing the PUF A from the defective PUF B using an error correction algorithm which produces a plurality of ambiguous results (A₁, A₂, . . . , Aₙ) for the PUF A in a fraction of cases and a single result, which may be incorrect, in all other cases; and
determining by means of the checksum C which of the plurality of ambiguous results (A₁, A₂, . . . , Aₙ) is the correct PUF A or whether a single result that has been obtained corresponds to the correct PUF A.

2. The method as claimed in claim 1, wherein the checksum C is produced by applying a cryptographic block cipher with the PUF A as a key to a bit string.

3. The method as claimed in claim 1, wherein the checksum C is produced by applying a linear feedback shift register to the PUF A.

4. The method as claimed in claim 1, wherein the length of PUF A and defective PUF B is from 100 bits to 5000 bits.

5. The method as claimed in claim 1, wherein an average error rate of the defective PUF B is from 0.3% to 15%.

6. The method as claimed in claim 1, wherein the error correction algorithm uses auxiliary information R for the reconstruction of the PUF A.

7. The method as claimed in claim 6, wherein the auxiliary information R comprises the checksum C.

8. The method as claimed in claim 6, wherein the auxiliary information R is public and the nonreproducibility of PUF A is provided by a third party.

9. The method as claimed in claim 1, wherein the method is performed on an electronic appliance.

10. The method as claimed in claim 9, wherein the electronic appliance is a chip card.

11. The method as claimed in claim 1, wherein the checksum C is stored on a read only memory of the electronic appliance.

12. The method as claimed in claim 11, wherein the read only memory is an EEPROM.

13. The method as claimed in claim 1, wherein the checksum C has a length from 30 bits to 150 bits.

14. The method as claimed in claim 1, further comprising creating a cryptographic key from the PUF A.

15. The method as claimed in claim 14, wherein the cryptographic key is used for encryption with block encryption or stream encryption.

16. The method as claimed in claim 15, wherein the cryptographic key is used for encryption with AES or Triple DES.

17. An apparatus for reconstructing a physically unclonable function (PUF) A, comprising:
a unit operable to produce a defective PUF B;
a read only memory operable to store a checksum C; and
a computation unit operable to reconstruct the PUF A from the defective PUF B using an error correction algorithm which produces a plurality of ambiguous results (A₁, A₂, . . . , Aₙ) for the PUF A in a fraction of cases and a single result, which may be incorrect, in all other cases, and which determines by means of the checksum C which of the plurality of ambiguous results (A₁, A₂, . . . , Aₙ) is the correct PUF A or whether a single result that has been obtained corresponds to the correct PUF A.

18. The apparatus as claimed in claim 17, wherein the length of the PUF A and defective PUF B is from 100 bits to 5000 bits.

19. The apparatus as claimed in claim 17, wherein an average error rate of the defective B is from 0.3% to 15%.

20. The apparatus as claimed in claim 17, wherein the error correction algorithm uses auxiliary information R for the reconstruction of the PUF A.

21. The apparatus as claimed in claim 20, wherein the auxiliary information R comprises the checksum C.

22. The apparatus as claimed in claim 20, wherein the auxiliary information R is stored in the read only memory.

23. The apparatus as claimed in claim 17, wherein the checksum C is stored in unencrypted form on the read only memory.

24. The apparatus as claimed in claim 17, wherein the read only memory is an EEPROM.

25. The apparatus as claimed in claim 17, wherein the checksum C has a length from 30 bits to 150 bits.

26. The apparatus as claimed in claim 17, further comprising a cryptographic unit operable to use a key produced from the PUF A for encryption with block encryption or stream encryption.
